(19) United States
(12) Patent Application Publication
(10) Pub. No.: US 2005/0058969 A1
(43) Pub. Date: Mar. 17, 2005

(54) Method and system for conveying how to replace a part using 3D computer models in animation

(76) Inventor: Christopher James Matthews, Austin, TX (US)

Correspondence Address: Christopher James Matthews, P.O. Box 7375, Austin, TX, 78713, US

(21) Appl. No.: 10/919,946

(22) Filed: Aug. 17, 2004

Related U.S. Application Data
(60) Provisional application No. 60/495,957, filed on Aug. 18, 2003.

(51) Int. Cl. G09B 19/00

(52) U.S. Cl. 434/118; 434/219

(57) ABSTRACT

A three dimensional computer animated method and system for conveying the proper method for removing and replacing machine parts from a manufactured apparatus without the use of any text or oral language descriptors. The entire process of disassembly and reassembly in the proper order is displayed via computer animation of the parts that comprise the apparatus. Tools are also displayed in the animations in use, and technical specifications necessary, such as exact torques numbers, are displayed on animated three dimensional models of the tools just as they are viewed in actuality.

### CROSS-REFERENCE TO RELATED APPLICATIONS

This application claims the benefit of provisional patent application Ser. No. 60/495,957, filed 2003 Aug. 18 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to an education and demonstration method, specifically to use three dimensional representations of apparatus parts via computer animation to teach the proper removal and replacement method of a part without the use of text or oral language descriptors.

2. Prior Art

Manufacturers of apparatuses are required to provide instructional information on how to replace parts thereby making it possible for the mechanism to maintain operation for a specified period of time. Drawings such as exploded assemblies with written instructions are currently used by manufacturers. However, not all the steps can be conveyed using this system; furthermore not everyone can easily appreciate all the features and difficulties involved in removing and replacing a part from the limited medium of line art. An apprentice system, which requires a great deal of supervision and expense, in addition to being limited by the personal knowledge of the instructor also suffers from numerous deficiencies. Improper removal and replacement of parts resulting from inadequate training is a serious and far reaching problem in an industrial country. In some cases the improper replacement of a single part in a complex mechanism causes catastrophic failure of the machine resulting in a loss of life.

### BACKGROUND OF THE INVENTION—OBJECTS AND ADVANTAGES

Accordingly, several objects and advantages of the present invention are:

(a) to provide animations that can be viewed in a hyper-accurate method of display, so inclusive and accurate that oral and text instructions are not only unnecessary, but undesirable, whereas viewing of the animations by this method can take place in a machine shop or manufacturing environment that is very noisy. In such environments oral narration is a hindrance since the effort to hear acts as a distraction, rather than a help.

(b) to provide training that will no longer take place in a classroom which increase both labor and cost but rather can take place during the hands-on actual replacement. The instructions will also act as a constant refresher to be played every time the part is replaced preventing even a mechanic familiar with the task from making a careless error, such as forgetting a step.

(c) to provide a training method that is completely visual so that no literacy is required as this training method is completely visual.

(d) to provide training that is instantly International.

(e) to provide a method that can be utilized by manufactures that ship apparatuses abroad since it eliminates any expensive language translations as neither written nor oral language descriptors are used.

Further objects and advantages will become apparent from a consideration of the ensuing description.

### SUMMARY

In accordance with the invention, a three dimension computer animated technical manual teaches how to remove and replace machine parts. The animations are hyper-accurate, appearing in the exact proportion, colour, and shape as the actual part. The apparatus appears completely assembled as it does in actuality. Each individual part in the actual apparatus is also contained in the virtual 3D animated model. The animations display the removal of each part in the proper order until the desired part that requires replacing is accessible. Tools required in the replacement are displayed in use, displaying, if applicable, any readings or output that a specialized tool may generate as it would be viewed in actuality. New parts to replace old ones would appear in the animation. The manufacturer's container, with the manufacturer's part numbers visible, allow for the correct identification of the part from the manufacturer's ordering system.

### DRAWINGS

Not Applicable

### DETAILED DESCRIPTION—PREFERRED EMBODIMENT

The present invention provides a method and system for conveying, via displaying 3D computer generated models, how to remove and replace machine parts with no text and no narration used as a descriptor. Because the 3D computer animated method of the present invention is completely visual it reduces the time needed to teach and learn how to remove and replace the machine part, and is instantly international in its application because it eliminates language barriers as it does not use written or oral descriptors. In one embodiment, the entire mechanism that contains a part in need of replacing is displayed completely assembled on the computer display. Each individual part is contained in the assembled virtual 3D model on the display as it is in the actual mechanism. The computer animation then displays the proper order in which to disassemble the mechanism. Screws untwist themselves and parts float apart in the animated computer 3D model. If a moment needs to be applied, specialized tools (e.g. torque wrenches) will appear and the exact specifications will be displayed on the virtual torque wrench as it should be on the actual torque wrench.

Part numbers will be included when appropriate, by having an animated model of the box containing the part with the manufacturer's logo, part number, and other identifying markings. The virtual part is replaced during the animation and the virtual model is reassembled in reverse order. Various “trouble shooting” approaches can also be mapped out in other animations enabling the technician to ascertain what part needs removing and replacing depending on the given problem. Using this 3D computer-model-in-animation-method reduces training hours and the likelihood of improper installation of a part since even the most minute steps that the technicians must follow are displayed by the computer 3D models in animation.

Although the description above contains many specificities, these should not be construed as listing the scope of the invention but as merely providing illustrations of some of the presently preferred embodiments of this invention. For example, the display could utilize a hologram, and virtual reality could be utilized to make the animations life size and indistinguishable from the actual mechanism, etc.

Thus the scope of the invention should be determined by the appended claims and their legal equivalents, rather than by the examples given.

1. A method of showing how to remove and replace a part from a manufactured apparatus, comprising:
(a) providing 3D computer animations depicting three dimensional representations of the machine parts assembling and disassembling completely and exclusively in a visual format, without any text instructions.
(b) providing said animated instructions without any oral narration.
(c) Providing said animated instructions without any labels,
whereby the said method can easily and instantly be understood by all regardless of language, hearing impairment, lack of prior knowledge, or literacy.

2. The method of claim 1 wherein said animation consists of a 3D representation of the assembled apparatus.

3. The method of claim 1 wherein said animation consists of 3D representations of all the parts that make up the assembled apparatus.

4. The method of claim 1 wherein said animation consists of 3D parts that are coloured and textured to appear identical to the actual part.

5. The method of claim 1 wherein said animation consists of 3D parts that are in exact proportion to the actual part.

6. The method of claim 1 wherein said animation contains 3D representations of tools used in the process.

7. The method of claim 1 wherein said animation contains technical specifications, such as numbers, that are displayed on any specialized tools, as they would be displayed in actuality on them, during the actual process.

8. The method of claim 1 wherein said animation shows the apparatus functioning properly when repaired, or malfunctioning, depending on the part that needs replacing and is causing the problem.

9. The method of claim 1 wherein said animation contains parts or groups of parts that blink in various colours, or become highlighted with spotlights while the rest of the concentrated area becomes shaded, to focus attention on an area or part.

10. The method of claim 1 wherein part numbers or the manufacturer's trade and identification marks are displayed on animated containers holding the parts to appear exactly as the manufacturer supplies those parts in actuality.
